(19) United States
(12) Patent Application Publication
(10) Pub. No.: US 2015/0025181 A1
(43) Pub. Date: Jan. 22, 2015

(54) POLYSTYRENE-BASED RESIN COMPOSITION AND LIGHT GUIDE PLATE FORMED BY MOLDING SAME

(71) Applicant: PS JAPAN CORPORATION, Tokyo (JP)

(72) Inventors: Mitsutoshi Toyama, Tokyo (JP); Jun Suzuki, Tokyo (JP); Kohei Yamashiro, Tokyo (JP); Jun Yazaki, Tokyo (JP)

(21) Appl. No.: 14/382,630

(22) PCT Filed: Apr. 2, 2013
(86) PCT No.: PCT/JP2013/060107

§ 371 Date: Sep. 3, 2014

(30) Foreign Application Priority Data
Apr. 2, 2012 (JP) 2012-083951
Jul. 9, 2012 (JP) 2012-153906
Oct. 4, 2012 (JP) 2012-222539

(51) Int. Cl. C08K 5/526; F21V 8/00; C08K 5/09; C08K 5/00; C08K 5/13; C08K 5/05

(52) U.S. Cl. CPC C08K 5/526; C08K 5/13; C08K 5/05; C08K 5/09; C08K 5/00; G02B 6/0065
USPC 524/151

(57) ABSTRACT

Provided are: a polystyrene-based resin composition which has low water absorption, excellent suppression of warping or dimensional changes in a molded article, and excellent optical properties, and is suitable for producing a shaped light guide plate of excellent mold separation performance; and a light guide plate obtained by molding the polystyrene-based resin composition. This polystyrene-based resin composition contains 100 parts by mass of a styrene-based resin and 0.02 to 0.2 parts by mass of a phosphorus-based antioxidant, wherein the amount of 4-t-butylcatechol contained per 1 g of styrene-based resin is 1 to 6 μg.

### TECHNICAL FIELD

The present invention relates to a polystyrene-based composition and a light guide plate formed by molding the resin composition. More particularly, the present invention relates to a styrene-based resin composition for forming a light guide plate that composes the backlight unit of a liquid crystal display device equipped with a light source such as an LED.

### BACKGROUND ART

The backlight units of liquid crystal display devices consist of a direct-lit type, in which the light source is arranged on the front of the display device, and an edge-lit type, in which the light source is arranged on the side of the display device. Light guide plates are used in edge-lit backlighting and fulfill the role of guiding light from the light source arranged on the side towards the front. Edge-lit backlighting is frequently used in applications requiring a thin design, such as televisions, personal computer monitors (including desktop and notebook personal computers), car navigation system monitors, cell phones and PDAs, and as a result of a growing number of opportunities for the use of edge-lit backlighting in large-screen televisions (having screen sizes of 32 inches or more), in which direct-lit backlighting had conventionally been used nearly exclusively, edge-lit backlighting has currently become the predominant type of backlighting used in these devices.

In the case of edge-lit backlighting, optical loss in the light guide plate is large due to the comparatively long distance over which light travels through the light guide plate, and in order to prevent this optical loss, the material used is required to have high optical transmittance. Consequently, although acrylic resins such as methyl methacrylate are frequently used in light wave guides, due to the high water absorption of acrylic resins, there is the problem of warping of a molded article when water has been absorbed from one side or the occurrence of dimensional changes when water has been absorbed from all sides, and these problems become more conspicuous as screen size increases.

On the other hand, since polystyrene-based resins have a low coefficient of water absorption (approx. 0.05%), they are free of problems such as warping or dimensional changes of molded articles. Although polystyrene-based resins are superior from the viewpoint of water absorption, their optical transmittance is inferior to that of acrylic-based resins. Since their optical transmittance at short wavelengths (up to 500 nm) in particular is low in comparison with that of acrylic resin, light that has passed through a polystyrene-based resin takes on a slightly yellow tint as light transmission distance increases, thereby resulting in the problem of having an effect on the color displayed by color liquid crystal displays. Consequently, although a combination of acrylic resin and polystyrene-based resin has been proposed for use as a light guide plate raw material (refer to the following Patent Documents 1 and 2), there have been hardly any cases involving the use of polystyrene-based resin alone, and studies to improve the optical properties of polystyrene-based resins have yet to be conducted.

In addition, light guide plates are also required to efficiently guide light to the front in order to improve the frontal luminance of liquid crystal televisions and the like. Finely shaping the surface of the light guide plate is effective for accomplishing this, and for example, mold separation performance is an important factor when transferring a shape formed on the surface of a mold to the surface of a light guide plate by shape transfer and the like.

### PRIOR ART DOCUMENTS

### Patent Documents

Patent Document 1: Japanese Unexamined Patent Publication No. 2001-342263
Patent Document 2: Japanese Unexamined Patent Publication No. 2003-75648

### DISCLOSURE OF THE INVENTION

### Problems to be Solved by the Invention

Although polystyrene demonstrates low water absorption and causes hardly any problems with respect to warping or dimensional changes of molded articles, since the optical transmittance thereof is inadequate, it is not necessarily satisfactory for use as a raw material of light guide plates. Thus, an object of the present invention is to provide a polystyrene-based resin composition that improves the optical transmittance and color tone of polystyrene-based resins and is suitable for the production of light guide plates.

### Means for Solving the Problems

As a result of conducting extensive studies to solve the aforementioned problems, the inventors of the present invention found that the aforementioned problems can be solved by containing a specific amount of a phosphorus-based antioxidant, a specific amount of 4-t-butylcatechol, a specific amount of a phenol-based antioxidant and a specific amount of a mold release agent in a styrene-based resin, and further adjusting the amount of trimers in the styrene-based resin and the total amount of dimers and trimers to be within specific ranges, thereby leading to completion of the present invention.

Namely, the present invention is as indicated below.

[1] A styrene-based resin composition containing 100 parts by mass of a styrene-based resin and 0.02 parts by mass to 0.2 parts by mass of a phosphorus-based antioxidant, wherein the amount of 4-t-butylcatechol per 1 g of the styrene-based resin is 1 μg to 6 μg.

[2] The styrene-based resin composition described in [1] above, further containing 0.02 parts by mass to 0.2 parts by mass of a phenol-based antioxidant.

[3] The styrene-based resin composition described in [1] or [2] above, wherein the total content of dimers and trimers per 1 g of the styrene-based resin is 5000 μg or less, and the content of a trimer component (1a-phenyl-4-e-(1′-phenylethyl)tetralin) represented by the following structural formula (I):

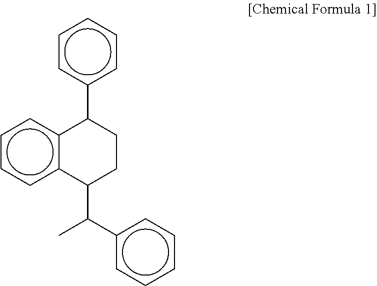

is less than 3000 μg.

[4] The styrene-based resin composition described in any of [1] to [3] above, further containing 0.1 parts by mass to 1.0 part by mass of a mold release agent.

[5] The styrene-based resin composition described in [4] above, wherein the mold release agent is a higher alcohol or a higher fatty acid.

[6] A light guide plate containing 100 parts by mass of a styrene-based resin and 0.02 parts by mass to 0.2 parts by mass of a phosphorus-based antioxidant, wherein the content of 4-t-butylcatechol per 1 g of the styrene-based resin is 1 μg to 6 μg.

[7] The light guide plate described in [6] above, further containing 0.02 parts by mass to 0.2 parts by mass of a phenol-based antioxidant.

[8] The light guide plate described in [6] or [7] above, wherein the total content of dimers and trimers per 1 g of the styrene-based resin is 5000 μg or less, and the content of a trimer component (1a-phenyl-4-e-(1′-phenylethyl)tetralin) represented by the following structural formula (I):

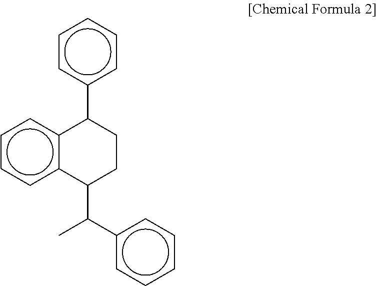

is less than 3000 μg.

[9] The light guide plate described in any of [6] to [8] above, further containing 0.1 parts by mass to 1.0 part by mass of a mold release agent. [10] The light guide plate described in [9] above, wherein the mold release agent is a higher alcohol or a higher fatty acid.

### Effects of the Invention

According to the present invention, a polystyrene-based resin composition can be provided that realizes low water absorption, suppression of warping and dimensional changes of a molded article and superior optical properties (optical transmittance, and particularly optical transmittance at short wavelengths). In addition, according to the present invention, a backlight of a liquid crystal display device such as that of a television or personal computer monitor, as well as a light guide plate preferable for use in a display device used in lighting equipment for interior and exterior space or in a billboard and the like, can be produced using this polystyrene-based resin composition.

### BEST MODE FOR CARRYING OUT THE INVENTION

The following provides a detailed explanation of embodiments of the present invention.

<Polystyrene-Based Resin Composition>

In an embodiment of the present invention, a polystyrene-based resin composition contains a polystyrene-based resin, a phosphorus-based antioxidant, 4-t-butylcatechol, a mold release agent and various types of suitable additives as desired.

(Polystyrene-Based Resin)

The polystyrene-based resin (or polymer) is a resin that contains a polystyrene-based monomer as a main component thereof (and more specifically, at more than 50% by mass). Examples of styrene-based monomers used to form the polystyrene-based resin include styrene, α-methylstyrene, para-methylstyrene, ethylstyrene, propylstyrene, butylstyrene, chlorostyrene and bromostyrene. Among these, styrene is preferable. In addition, a copolymer obtained by copolymerizing styrene with a comonomer that is copolymerizable with styrene may also be used for the polystyrene-based resin. Examples of comonomers that are copolymerizable with styrene include (meth)acrylic acid esters such as methyl (meth)acrylate, ethyl (meth)acrylate or butyl (meth)acrylate, aromatic vinyl monomers other than styrene such as α-methylstyrene, o-, m- or p-methylstyrene, bromostyrene, dibromostyrene, chlorostyrene or dichlorostyrene, unsaturated fatty acids such as (meth)acrylic acid, maleic acid or fumaric acid, fatty acid anhydrides such as maleic anhydride or itaconic anhydride, and unsaturated difatty acid imides such as N-phenylmaleimide. One type of these monomers can be used alone or two or more types can be used in combination.

In an embodiment of the present invention, the polystyrene-based resin can be obtained by thermopolymerizing a monomer component containing a styrene-based monomer or by polymerizing using one type or a plurality of types of organic peroxides as a polymerization initiator. Specific examples of organic peroxides include peroxyketals such as 1,1-bis(t-butylperoxy)cyclohexane, dialkyl peroxides such as di-t-butylperoxide or 2,5-dimethyl-2,5-di(t-butylperoxy)hexane, diacyl peroxides such as benzoyl peroxide or m-toloyl peroxide, peroxyesters such as dimyristyl peroxycarbonate, ketone peroxides such as cyclohexanone peroxide, hydroperoxides such as p-menthahydroperoxide, and multifunctional peroxides such as 2,2-bis(4,4-ditertiary-butylperoxycyclohexyl)propane, 2,2-bis(4,4-ditertiary-amylperoxycyclohexyl)propane, 2,2-bis(4,4-ditertiary-butylperoxycyclohexyl)butane or 2,2-bis(4,4-dicumylperoxycyclohexyl)propane.

These organic peroxides are added to the polymerization scheme (polymerization raw material solution or polymerization intermediate solution) in any step for polymerizing a monomer component that contains styrene-based monomer. These organic peroxides may be added to the polymerization raw material solution or may be added by dividing among a plurality of additions as necessary to a polymerization intermediate solution. The amount of organic peroxide added is preferably 0.0005 parts by mass to 0.2 parts by mass, more preferably 0.01 parts by mass to 0.1 parts by mass and even more preferably 0.03 parts by mass to 0.08 parts by mass, based on 100 parts by mass of the polymerization raw material solution. If the added amount of organic peroxide is 0.0005 parts by mass or more, the desired effect of adding the polymerization initiator can be obtained, thereby making this preferable, while if the added amount of organic peroxide is 0.2 parts by mass or less, there is little reaction heat generated during polymerization and polymerization can be easily controlled, thereby making this preferable.

In a typical aspect of the present invention, 4-t-butylcatechol to be subsequently described is preferably used as a polymerization inhibitor when storing the styrene-based monomer.

Examples of methods used to polymerize the monomer component containing the styrene-based monomer include bulk polymerization, solution polymerization, suspension polymerization and emulsion polymerization. Among these, bulk polymerization or solution polymerization is preferable and continuous bulk polymerization or continuous solution polymerization is particularly preferable in terms of both productivity and economy. In other words, polymerization of the monomer component containing the styrene-based monomer can be carried out by mixing and dissolving the monomer component containing the styrene-based monomer with, as necessary, a polymerization solvent such as ethyl benzene, toluene or xylene, radical initiator in the form of an organic peroxide, chain transfer agent, stabilizer or other additives such as liquid paraffin (mineral oil), followed by supplying the resulting raw material solution to a reactor equipped with a stirrer. In the case of using an organic peroxide for the radical initiator, the polymerization temperature can be set using a known technology in consideration of such factors as the decomposition temperature of the organic peroxide, productivity, heat dissipation capacity of the reactor and target fluidity of the styrene-based polymer. Polymer solution that has left the polymerization reactor is guided to a recovery apparatus in a degassing step where solvent and unreacted monomers are removed by heating and vacuum devolatilization. An apparatus ordinarily used in the production of polystyrene-based resin can be used for the recovery apparatus, and examples thereof include a flush tank system or multistage vented extruder.

Any of a complete mixing type, plug flow type or plug flow type equipped with a circulator can be preferably used for the polymerization apparatus for the polymerization raw material containing the styrene-based monomer. Among these, a complete mixing type of polymerization apparatus is preferable due to the uniform distribution of materials.

(Phosphorus-Based Antioxidant and Phenol-Based Antioxidant)

The phosphorus-based antioxidant is an antioxidant that contains a compound having a phosphorus atom in a molecule thereof. Since phosphorus-based antioxidants demonstrate stabilizing action by reducing hydroperoxide that causes deterioration at high temperatures, they contribute to improvement of optical transmittance at comparatively short wavelengths (for example, wavelengths of 420 nm to 500 nm), and particularly contribute to reduction of pale yellow coloring. Examples of phosphorus-based antioxidants include alkyl phosphites, alkyl aryl phosphites and aryl phosphites, and products such as ADK Stab PEP-8, ADK Stab PEP-36, ADK Stab HP-10 or ADK Stab 2112 manufactured by Adeka Corp. can be acquired industrially. Among these, ADK Stab 2112 (tris(2,4-di-t-butylphenyl)phosphite), represented by the following structural formula (II):

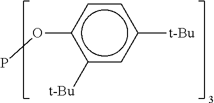

is preferable from the viewpoint of reducing pale yellow coloring.

Phenol-based antioxidants are antioxidants that contain a hindered phenol structure in a molecule thereof. Phenol-based antioxidants inhibit the progress of the deterioration cascade by capturing peroxy radicals generated by autooxidation and converting them to semi-stable hydroperoxides. The hydroperoxides are then stabilized by being further reduced by the phosphorus-based antioxidant. As a result, phenol-based antioxidants contribute to improvement of the retention rate of optical transmittance during exposure to high temperatures, and particularly contribute to reduction of pale yellow coloring during use in high-temperature environments. Products such as Irganox 1010 or Irganox 1076, manufactured by BASF Japan Ltd., can be acquired industrially. Among these, Irganox 1076 stearyl (3-(3,5-di-t-butyl-4-hydroxyphenyl)propionate represented by the following structural formula (III):

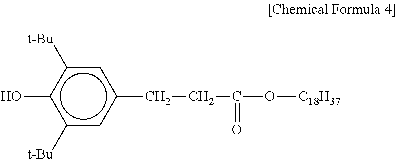

is preferable from the viewpoint of reducing pale yellow coloring during use in high-temperature environments.

In addition, Sumilizer GP (6-[3-(3-t-butyl-4-hydroxy-5-methylphenyl)propoxy]-2,4,8,10-tetra-t-butylbenz[d,f][1,3,2]dioxaphosphepin), manufactured by Sumitomo Chemical Co., Ltd., can also be preferably used as a phenol-based antioxidant also having a phosphite structure within the same molecule thereof.

The content of phosphorus-based antioxidant in the polystyrene-based resin composition is 0.02 parts by mass to 0.2 parts by mass per 100 parts by mass of the polystyrene-based resin. If this content is 0.02 parts by mass or more, decreases in optical transmittance caused by deterioration at high temperatures, such as when the resin melts during molding, can be inhibited, while on the other hand, if the content is 0.2 parts by mass or less, there is the advantage of eliminating the formation of mold deposits or advantages in terms of cost. The content is preferably 0.03 parts by mass to 0.15 parts by mass and more preferably 0.04 parts by mass to 0.12 parts by mass.

The content of the phenol-based antioxidant in the polystyrene-based resin composition is 0.02 parts by mass to 0.2 parts by mass per 100 parts by mass of the polystyrene-based resin. If this content is 0.02 parts by mass or more, decreases in optical transmittance caused by deterioration at environmental temperatures during use as a light guide plate (room temperature to about 70° C.) can be inhibited, while on the other hand, if the content is 0.2 parts by mass or less, there is the advantage of being able to prevent decreases in optical transmittance caused by the phenol-based antioxidant per se or advantages in terms of cost. The content is preferably 0.03 parts by mass to 0.15 parts by mass and more preferably 0.04 parts by mass to 0.12 parts by mass.

In the case of using a compound that acts as both a phosphorus-based antioxidant and phenol-based antioxidant (such as a compound containing both a phosphite structure and hindered phenol structure in a molecule thereof, and more specifically, the previously described Sumilizer GP manufactured by Sumitomo Chemical Co., Ltd.) (to also be referred to as a phosphorus-based phenol-based antioxidant), the respective contents of the phosphorus-based antioxidant and phenol-based antioxidant are considered to be contained in the content of the phosphorus based phenol-based antioxidant. For example, in the case 0.1 part by mass of a phosphorus-based phenol-based antioxidant is contained based on 100 parts by mass of the polystyrene-based resin, 0.1 parts by mass of phosphorus-based antioxidant and 0.1 parts by mass of phenol-based antioxidant are considered to be contained based on 100 parts by mass of the polystyrene-based resin.

Furthermore, the contents of phosphorus-based antioxidant and phenol-based antioxidant in the polystyrene-based resin composition disclosed here are measured using gas chromatography.

(4-t-butylcatechol)

In the embodiments of the present invention, 4-t-butylcatechol (to be referred to as “TBC”) is contained in the polystyrene-based resin composition. Although the TBC in the polystyrene-based resin composition is typically the TBC that remains following use in the production of the polystyrene-based resin, the TBC may also be contained in the polystyrene-based resin composition following production of the polystyrene-based resin. In addition, the concentration of 4-t-butylcatechol (to be referred as the “TBC concentration”) per 1 g of the polystyrene-based resin is within the range of 1 μg/g to 6 μg/g. If the TBC concentration is 1 μg/g or more, decreases in optical transmittance caused by the combined use of the polystyrene-based resin and phosphorus-based antioxidant as a result of combining with the use of the phosphorus-based antioxidant can be inhibited, while on the other hand, if the TBC concentration is 6 μg/g or less, decreases in optical transmittance caused by coloring attributable to the 4-t-butylcatehol per se can be prevented. In addition, the TBC concentration is preferably 1 μg/g to 5 μg/g and more preferably 1.2 μg/g to 3 μg/g. Furthermore, the aforementioned TBC concentration is the value determined by measuring the concentration in the polystyrene-based resin composition by gas chromatography-mass spectrometry followed by converting to the value per 1 g of polystyrene-based resin (polymer).

(Styrene Dimers and Trimers)

In the embodiments of the present invention, dimers and/or trimers of the styrene-based monomer are preferably contained such that the total content of dimers and trimers is 5000 μg or less per 1 g of styrene-based resin. If the content of dimers and trimers is 5000 μg or less, the mean transmittance at 500 nm to 600 nm in a resin molded article having an optical path length of 300 mm falls below 83%. Although the content of dimers and trimers is preferably the lower the better, at the current level of technology, the lower limit thereof is about 1500 ppm. Examples of means for controlling the amounts of dimers and trimers include inhibition of side reactions by lowering the polymerization temperature, inhibition of resin decomposition by adding a stabilizer, and removal of impurities by purifying the raw material.

Dimers or trimers of the styrene-based monomer can be formed as by-products corresponding to the polymerization reaction conditions of the styrene-based monomer. Examples of dimers include the styrene dimers represented by the following structural formulas (a) and (b).

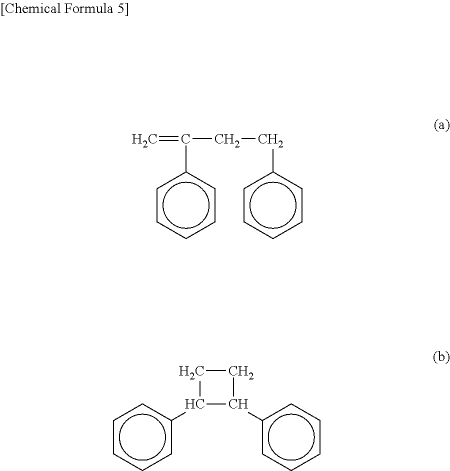

In an embodiment of the present invention, the styrene-based resin contains a trimer of the styrene-based monomer in the form of a compound represented by the following general formula (I):

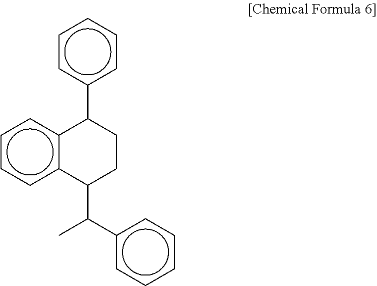

namely, 1a-phenyl-4a-(1′-phenylethyl)tetralin (to also be referred to as “Trimer 2”). The content of Trimer 2 in the styrene-based resin is preferably less than 3000 μg (namely, 3000 ppm) and more preferably less than 1000 ppm per 1 g of the styrene-based resin. Although the lower limit of the content thereof is preferably the lower the better, at the current level of technology, the lower limit is about 500 ppm. In the case the content of the Trimer 2 is 3000 ppm or more, optical transmittance at a wavelength of 500 nm to 600 nm in a resin molded article having an optical path length of 300 nm falls below 83%.

Furthermore, other examples of trimers of the styrene-based monomer in addition to the aforementioned Trimer 2 include styrene trimers represented by the following structural formulas (c) and (d).

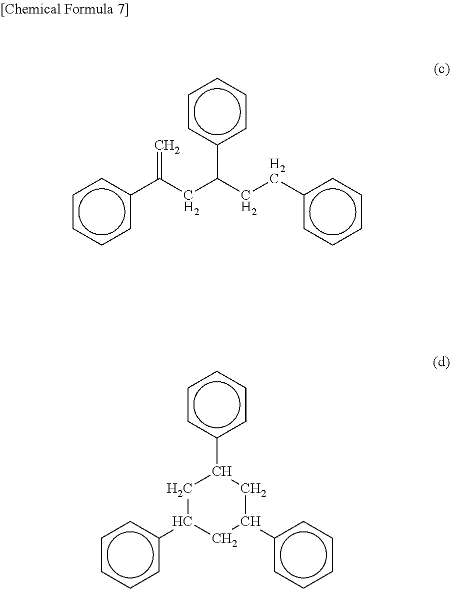

Although solvent and unreacted monomer is removed using a means such as heating and vacuum devolatilization in a degassing step when producing the polystyrene-based resin, 4-t-butylcatechol that was not consumed in the polymerization step is also removed simultaneously. Normally, although the resin temperature and/or degree of vacuum are set to a level that prevents the occurrence of resin decomposition and the like in order to efficiently remove solvent and unreacted monomer in the degassing step, in the present invention, by carrying out the degassing step at a comparatively low resin temperature and low degree of vacuum, the desired 4-t-butylcatechol is allowed to remain in the resin.

(Mold Release Agent)

A higher alcohol or higher fatty acid is preferable for the mold release agent in the styrene-based resin composition of the present invention. The use of other types of mold release agents makes it difficult to collectively improve color tone, optical transmittance and mold separation performance.

(Higher Alcohol)

Examples of higher alcohols include monovalent alcohols having 6 to 20 carbon atoms, and specific examples thereof include octyl alcohol, decyl alcohol, lauryl alcohol, myristyl alcohol, cetyl alcohol and stearyl alcohol. The content of the higher alcohol is 0.1 parts by mass to 1 part by mass and preferably 0.2 parts by mass to 0.8 parts by mass based on 100 parts by mass of the styrene-based resin. If the content of the higher alcohol is less than 0.1 parts by mass, there is the risk of an absence of improvement of mold separation performance, while if the content of the higher alcohol exceeds 1 part by mass, there is the risk of decreases in heat resistance and strength.

(Higher Fatty Acid)

Examples of higher fatty acids include fatty acids having 12 to 20 carbon atoms, and specific examples thereof include lauric acid, myristic acid, palmitic acid and stearic acid. The content of the higher fatty acid is 0.1 parts by mass to 1 part by mass and preferably 0.2 parts by mass to 0.8 parts by mass based on 100 parts by mass of the styrene-based resin. If the content of the higher fatty acid is less than 0.1 parts by mass, there is the risk of an absence of improvement of mold separation performance, while if the content of the higher fatty acid exceeds 1 part by mass, there is the risk of decreases in heat resistance and strength.

(Additives)

In the embodiments of the present invention, various types of additives may be added to the system as necessary within a range that does not impair the action and effects of the present invention, either at an arbitrary stage before or after the recovery step of the polystyrene-based resin during production of the polystyrene-based resin, or at the stage at which the extrusion step or molding step and the like is carried out using the polystyrene-based resin composition. In a preferable aspect thereof, the polystyrene-based resin composition can contain at least one additive selected from the group consisting of an ultraviolet absorber, photostabilizer, antioxidant other than a phosphorus-based antioxidant or phenol-based antioxidant (such as a sulfur-based antioxidant), lubricant, antistatic agent, flame retardant, dye or pigment, fluorescent whitener and wavelength selective absorber. In a more preferable aspect thereof, the polystyrene-based resin composition can contain at least one additive selected from the group consisting of an ultraviolet absorber, photostabilizer and lubricant. The following provides an explanation of specific examples of preferable additives.

A polystyrene-based resin composition suitable for a light guide plate can contain an ultraviolet absorber and/or photostabilizer for the purpose of preventing coloring caused by ultraviolet light generated from the light source. Examples of ultraviolet absorbers include benzotriazole-based ultraviolet absorbers such as 2-(5-methyl-2-hydroxyphenyl)benzotriazole, 2-[2-hydroxy-3,5-bis(α,α′-dimethylbenzyl)phenyl]benzotriazole or 2-(3,5-di-t-amyl-2-hydroxyphenyl)benzotriazole, benzophenone-based ultraviolet absorbers such as 2-hydroxy-4-methoxybenzophenone, 2,2′-dihydroxy-4-methoxybenzophenone or 2-hydroxy-4-n-octoxybenzophenone, salicylic acid-based ultraviolet absorbers such as phenyl salicylate or 4-t-buylphenyl salicylate, 2-(1-arylalkydene)malonic acid ester-based ultraviolet absorbers and oxalanilide-based ultraviolet absorbers. In addition, examples of photostabilizers include hindered amine-based photostabilizers. Examples of hindered amine-based photostabilizers include bis(2,2,6,6-tetramethyl-4-piperidyl)sebacate and N,N′-bis-(3-aminopropyl)ethylenediamine-2,4-bis[N-butyl-N-(1,2,2,6,6-pentamethyl-4-piperidyl)amino]-6-chloro-1,3,5-triazine condensates. One or a plurality of the ultraviolet absorbers and photostabilizers can be used, and the amount added thereof as the total amount of ultraviolet absorber and photostabilizer is preferably 0.02 parts by mass to 2.0 parts by mass and more preferably 0.1 parts by mass to 1.5 parts by mass based on 100 parts by mass of the polystyrene-based resin.

Examples of antioxidants other than the phosphorus-based antioxidant and phenol-based antioxidant include sulfur-based antioxidants. Antioxidants other than the phosphorus-based antioxidant and phenol-based antioxidant can be suitably added as necessary.

Examples of lubricants include aliphatic hydrocarbon-based lubricants such as liquid paraffin. The content of the lubricant is preferably 0.05 parts by mass to 5 parts by mass based on 100 parts by mass of the polystyrene-based resin.

Examples of antistatic agents include nonionic surfactants such as glycerin fatty acid ester and high molecular weight surfactants such as sulfonic acid-formalin condensates. The content of the antistatic agent is preferably 0.5 parts by mass to 25 parts by mass and more preferably 0.5 parts by mass to 15 parts by mass based on 100 parts by mass of the polystyrene-based resin.

Moreover, a masking agent such as a fluorescent whitener or bluing agent can also be arbitrarily used as necessary in a styrene-based resin composition suitable for a light guide plate.

(Light Guide Plate)

In an embodiment of the present invention, a light guide plate is obtained by molding the aforementioned polystyrene-based resin composition. A known method can be used for the molding method, and examples thereof include a method for obtaining a molded sheet by molding with a sheet molding extruder and a method for obtaining a molded article of a desired shape by compression molding or injection molding and the like.

In addition, in an embodiment of the present invention, the light guide plate preferably contains 0.4 μg/g to 5.4 μg/g of 4-t-butylcatechol per 1 g of the light guide plate. If the concentration of 4-t-butylcatechol in the light guide plate is 0.4 μg/g or more, decreases in optical transmittance can be inhibited, thereby making this preferable, while on the other hand, if the concentration of 4-t-butylcatechol is 5.4 μg/g or less, decreases in optical transmittance caused by coloring of the 4-t-butylcatechol per se do not occur, thereby making this preferable. In addition, the concentration of 4-t-butylcatehol in the light guide plate is more preferably 0.4 μg/g to 4.5 μg/g and even more preferably 0.5 μg/g to 2.7 μg/g. The aforementioned 4-t-butylcatechol concentration is the value determined by measuring by gas chromatography-mass spectrometry.

A light guide plate obtained by molding the polystyrene-based resin composition as previously described has superior optical properties (more specifically, optical transmittance, and particularly short-wavelength optical transmittance). More specifically, the light guide plate has mean transmittance of parallel light over a wavelength range of 500 nm to 600 nm for an optical path length of 300 mm (indicated by “B” in the following Tables 1 and 2) of preferably 83% or more, more preferably 84% or more and even more preferably 85% or more. A mean transmittance of parallel light over a wavelength range of 500 nm to 600 nm of 83% or more is advantageous in terms of superior optical properties. Although the mean transmittance is preferably the higher the better, from the viewpoint of the refractive indices of the materials, it is preferably, for example, 93% or less and more preferably 91% or less.

In addition, the light guide plate also has superior wavelength selectivity (namely, a difference in optical transmittance according to wavelength), and more specifically, is such that the ratio of mean transmittance of parallel light over a wavelength range of 420 nm to 500 nm (indicated by “A” in the following Tables 1 and 2) to mean transmittance of parallel light over a wavelength range of 500 nm to 600 nm (indicated by “B” in the following Tables 1 and 2), for an optical path length of 300 mm (mean transmittance (%) of parallel light over a wavelength of 420 nm to 500 nm/mean transmittance (%) of parallel light over a wavelength range of 500 nm to 600 nm, namely A/B), is preferably 0.92 or more and more preferably 0.93 or more. An aforementioned ratio of 0.92 or more is advantageous in terms of superior optical properties, and particularly advantageous in terms of inhibiting pale yellow coloring.

In addition, the light guide plate also has superior optical transmittance following high-temperature treatment, and the mean transmittance retention rate ((C/A)×100), as defined by the ratio of mean transmittance of parallel light over a wavelength range of 420 nm to 500 nm following exposure treatment for 500 hours at 80° C. (indicated by “C” in the following Tables 1 and 2) to the aforementioned mean transmittance (%) of parallel light over a wavelength of 420 nm to 500 nm, for an optical path length of 300 mm, is 93% or more, preferably 95% or more, more preferably 95.5% or more and even more preferably 96% or more. An aforementioned retention rate of 95% or more is advantageous in terms of inhibiting coloring (and particularly pale yellow coloring) even in the case of using the light guide plate in an environment that is continuously heated by a heat source such as a light source.

In a light guide plate according to a preferred aspect thereof, for an optical path length of 300 mm, the values for mean transmittance of parallel light over a wavelength range of 500 nm to 600 nm, ratio of mean transmittance of parallel light over a wavelength range of 420 nm to 500 nm to mean transmittance of parallel light over a wavelength range of 500 nm to 600 nm, and the aforementioned retention rate of mean transmittance, are all within the aforementioned ranges.

Furthermore, optical transmittance as disclosed herein is measured using a long path length transmission spectrophotometer. In addition, mean transmittance refers to the numerical average of optical transmittance over the measured wavelength range.

As has been explained above, the light guide plate of the present invention having superior optical transmittance and wavelength selectivity is preferable for the backlighting of the liquid crystal display devices of televisions or personal computer monitors and the like.

### EXAMPLES

The following provides a detailed explanation of the present invention. However, the present invention is not limited by these examples.
(1) Measurement of 4-t-butylcatechol (TBC) Concentration

1 g of composition (such as pellets or a molded article) was dissolved in 20 ml of chloroform followed by carrying out trimethylsilyl derivation treatment using N,O-bis(trimethylsilyl)trifluoroacetoamide (BSTFA) and measuring the supernatant obtained by separating by centrifugal separation with a gas chromatograph-mass spectrometer (GC-MS). A preliminarily prepared calibration curve was used to determine concentration.
GC/MS Measurement Conditions:
GC system: Agilent 6890
Column: DB-1 (0.25 mm i.d.×30 m)
Liquid phase thickness: 0.25 mm
Column temperature: 40° C. (held for 5 min)→(heating at 20° C./min)→320° C. (held for 6 min), total: 25 min
Injection port temperature: 320° C.
Injection method: Split method (split ratio: 1:5)
Sample volume: 2 μl
MS system: Agilent MSD5973
Ion source temperature: 230° C.
Interface temperature: 320° C.
Ionization method: Electron ionization (SI) method
Measurement method: SCAN method (scanning range m/z: 10 to 180)
(2) Measurement of Phosphorus-based Antioxidant and Phenol-Based Antioxidant Concentrations

1 g of composition (such as pellets or a molded article) was adequately dissolved in 20 ml of methyl ethyl ketone followed by dropping in 5 ml of methanol and stirring for about 20 minutes. Supernatant obtained by separating by centrifugal separation was measured with a gas chromatograph (GC). A preliminarily prepared calibration curve was used to determine the concentration of each antioxidant.
GC/MS Measurement Conditions:
GC system: GTC-2010, Shimadzu Corp.
Column: DB-1 (0.25 mm i.d.×30 m)
Liquid phase thickness: 0.10 mm
Column temperature: 240° C. (held for 1 min)→(heating at 10° C./min)→320° C. (held for 5 min), total: 14 min
Injection port temperature: 320° C.
Injection method: Split method (split ratio: 1:5)
Sample volume: 1 μl
(3) Measurement of Styrene Dimers and Trimers

1 g of composition (such as pellets or a molded article) was adequately dissolved in 10 ml of methyl ethyl ketone followed by dropping in 3 ml of methanol and stirring for about 20 minutes. Supernatant obtained by separating by centrifugal separation was measured with a gas chromatograph (GC). Each dimer and trimer was able to be analyzed based on differences in retention time. A preliminarily prepared calibration curve was used to determine concentration.
GC/MS Measurement Conditions:
GC system: Agilent 6850 Series GC System
Column: Agilent 19091Z-413E
Injection port temperature: 250° C.
Detector temperature: 280° C.

Furthermore, the contents of TBC, phosphorus-based antioxidant, phenol-based antioxidant and styrene dimers and trimers per 1 g of polymer were determined by converting after having measured their respective concentrations in the composition as previously described.
(4) Measurement of Transmittance Ratio of Parallel Light
Over each Wavelength Range (420 nm to 500 nm, 500 nm to 600 nm)

A test piece measuring 300×20×4 (mm) was fabricated by injection molding followed by measurement of transmittance of parallel light at each wavelength for an optical path length of 300 mm using the ASA-1 Long Path Length Transmission Spectrophotometer manufactured by Nippon Denshoku Industries Co., Ltd. The ratio (A/B) of optical transmittance was calculated by using the mean transmittance (%) of parallel light over a wavelength range of 420 nm to 500 nm (A) and the mean transmittance (%) of parallel light over a wavelength range of 500 nm to 600 nm (B). A higher value indicates greater inhibition of pale yellow coloring.
(5) Measurement of Retention Rate of Mean Transmittance by Exposure

A test piece measuring 300×20×4 (mm) fabricated by injection molding was used. The test piece was exposed for 500 hours in a chamber set to a temperature of 80° C. using the GPH-201 Gear Oven manufactured by Espec Corp. Following exposure, the test piece was measured for transmittance of parallel light at each wavelength for an optical path length of 300 mm using the ASA-1 Long Path Length Transmission Spectrophotometer manufactured by Nippon Denshoku Industries Co., Ltd. The retention rate of mean transmittance of parallel light due to exposure ((C/A)×100) was calculated using the mean transmittance (%) of parallel light over a wavelength range of 420 nm to 500 nm (A) and the mean transmittance (%) of parallel light over a wavelength range of 420 nm to 500 nm after exposure (C). A higher value for retention rate indicates less deterioration attributable to heat exposure.
(6) Evaluation of Mold Separation Performance

Mold separation performance was evaluated based on the maximum amount of retained pressure that allowed a molded article to be removed when a lattice-shaped molded article was molded by injection molding. A large value for retained pressure indicates favorable mold separation performance.

### Example 1

### Production of Polystyrene-Based Resin Composition

A polymerization solution obtained by adding 0.05 parts by mass of 1,1-bis(t-butylperoxy)cyclohexane to 100 parts by mass of a mixed liquid of 85% by mass styrene (TBC concentration: 11 μg/g) and 15% by mass ethyl benzene was continuously charged into a 5.4 liter complete mixing reactor at the rate of 0.70 liters/hr followed by adjusting the temperature to 101° C. Next, the resulting solution was continuously charged into a 3.0 liter laminar flow reactor equipped with a stirrer and capable of temperature control of three zones. The temperatures in the laminar flow reactor were adjusted to 113° C., 121° C. and 128° C. A polymer solution was obtained as a result thereof.

The resulting polymer solution was continuously supplied to a two-stage vented devolatilizing extruder, and after recovering unreacted monomer and solvent at an extruder temperature of 225° C. and degree of vacuum of 15 torr for the first stage vent and second stage vent, phosphorus-based antioxidant (tris(2,4-di-t-butylphenyl)phosphite, trade name: ADK Stab 2112) was added through the additive feed port at concentrations of 0.05 parts by mass and 0.05 parts by mass, respectively, based on 100 parts by mass of the polymer to obtain a styrene-based resin composition. The monomer polymerization rate was calculated from the mass yield to be 68%. The TBC concentration in the resulting polystyrene-based resin was 1.5 μg/g.

Analysis and evaluation results are shown in the following Table 1.

### Example 2

A polystyrene-based resin composition was obtained using the same method as Example 1 with the exception of adding phosphorus-based antioxidant (tris(2,4-di-t-butylphenyl)phosphite, trade name: ADK Stab 2112) to a concentration of 0.10 parts by mass based on 100 parts by mass of the polymer.

### Example 3

A polymerization solution obtained by adding 0.01 parts by mass of 1,1-bis(t-butylperoxy)cyclohexane to 100 parts by mass of a mixed liquid of 89% by mass styrene (TBC concentration: 11 μg/g) and 11% by mass ethyl benzene was continuously charged into a 5.4 liter complete mixing reactor at the rate of 0.70 liters/hr followed by adjusting the temperature to 117° C. Next, the resulting solution was continuously charged into a 3.0 liter laminar flow reactor equipped with a stirrer and capable of temperature control of three zones. The temperatures in the laminar flow reactor were adjusted to 128° C., 135° C. and 141° C. A polymer solution was obtained as a result thereof.

The resulting polymer solution was continuously supplied to a two-stage vented devolatilizing extruder, and after recovering unreacted monomer and solvent at an extruder temperature of 225° C. and degree of vacuum of 15 torr for the first stage vent and second stage vent, phosphorus-based antioxidant (tris(2,4-di-t-butylphenyl)phosphite, trade name: ADK Stab 2112) was added through the additive feed port at a concentration of 0.05 parts by mass based on 100 parts by mass of the polymer to obtain a styrene-based resin composition. The monomer polymerization rate was calculated from the mass yield to be 75%. The TBC concentration in the resulting polystyrene-based resin was 1.2 μg/g.

### Example 4

A polystyrene-based resin composition was obtained using the same method as Example 1 with the exception of changing the TBC concentration in the styrene used to 25 μg/g. The TBC concentration in the resulting polystyrene-based resin was 5.5 μg/g.

### Example 5

A polystyrene-based resin composition was obtained using the same method as Example 1 with the exception of adding a phenol-based antioxidant (stearyl (3-(3,5-di-t-butyl-4-hydroxyphenyl)propionate, trade name: Irganox 1076) at a concentration of 0.05 parts by mass based on 100 parts by mass of the polymer.

### Example 6

A polystyrene-based resin composition was obtained using the same method as Example 5 with the exception of adding a phosphorus-based antioxidant (tris(2,4-di-t-butylphenyl)phosphite, trade name: ADK Stab 2112) at a concentration of 0.10 parts by mass based on 100 parts by mass of the polymer.

### Example 7

A polystyrene-based resin composition was obtained using the same method as Example 1 with the exception of adding a phenol-based antioxidant (stearyl (3-(3,5-di-t-butyl-4-hydroxyphenyl) propionate, trade name: Irganox 1076) at a concentration of 0.10 parts by mass based on 100 parts by mass of the polymer.

### Example 8

A polystyrene-based resin composition was obtained using the same method as Example 6 with the exception of adding stearyl alcohol to a concentration of 0.4 parts by mass based on 100 parts by mass of the polymer.

### Example 9

A polystyrene-based resin composition was obtained using the same method as Example 7 with the exception of adding stearyl alcohol at a concentration of 0.4 parts by mass based on 100 parts by mass of the polymer.

### Example 10

A polystyrene-based resin composition was obtained using the same method as Example 1 with the exception of adding a phenol-based antioxidant (stearyl (3-(3,5-di-t-butyl-4-hydroxyphenyl)propionate, trade name: Irganox 1076) at a concentration of 0.30 parts by mass based on 100 parts by mass of the polymer.

### Example 11

A polystyrene-based resin composition was obtained using the same method as Example 1 with the exception of changing the TBC concentration in the styrene used to 25 μg/g and adding a phenol-based antioxidant (stearyl (3-(3,5-di-t-butyl-4-hydroxyphenyl)propionate, trade name: Irganox 1076) at a concentration of 0.05 parts by mass based on 100 parts by mass of the polymer. The TBC concentration in the resulting polystyrene-based resin was 5.5 μg/g.

### Example 12

A polystyrene-based resin composition was obtained using the same method as Example 3 with the exception of adding a phenol-based antioxidant (stearyl (3-(3,5-di-t-butyl-4-hydroxyphenyl)propionate, trade name: Irganox 1076) at a concentration of 0.05 parts by mass based on 100 parts by mass of the polymer.

### Example 13

A polystyrene-based resin composition was obtained using the same method as Example 11 with the exception of adding stearyl alcohol at a concentration of 0.4 parts by mass based on 100 parts by mass of the polymer.

### Example 14

A polystyrene-based resin composition was obtained using the same method as Example 12 with the exception of adding stearyl alcohol at a concentration of 0.4 parts by mass based on 100 parts by mass of the polymer.

### Example 15

A polystyrene-based resin composition was obtained using the same method as Example 5 with the exception of using the mixture recovered in the devolatilizing extruder (unreacted styrene, ethyl benzene, etc.) without purifying a portion thereof for a portion of the raw materials, and adding stearyl alcohol at a concentration of 0.4 parts by mass based on 100 parts by mass of the polymer.

### Example 16

A polystyrene-based resin composition was obtained using the same method as Example 5 with the exception of adding stearyl alcohol at a concentration of 0.2 parts by mass based on 100 parts by mass of the polymer.

### Example 17

A polystyrene-based resin composition was obtained using the same method as Example 5 with the exception of adding stearyl alcohol at a concentration of 0.4 parts by mass based on 100 parts by mass of the polymer.

### Example 18

A polystyrene-based resin composition was obtained using the same method as Example 5 with the exception of adding stearic acid at a concentration of 0.2 parts by mass based on 100 parts by mass of the polymer.

### Example 19

A polystyrene-based resin composition was obtained using the same method as Example 5 with the exception of adding erucamide at a concentration of 0.4 parts by mass based on 100 parts by mass of the polymer.

### Example 20

A polystyrene-based resin composition was obtained using the same method as Example 1 with the exception of adding a phenol-based antioxidant (6-[3-(3-t-butyl-4-hydroxy-5-methylphenyl)propoxy]-2,4,8,10-tetra-t-butylbenz[d,f][1,3,2]dioxaphosphepin), trade name: Sumilizer GP manufactured by Sumitomo Chemical Co., Ltd.) at a concentration of 0.05 parts by mass based on 100 parts by mass of the polymer.

### Example 21

A polystyrene-based resin composition was obtained using the same method as Example 1 with the exception of adding a phenol-based antioxidant (6-[3-(3-t-butyl-4-hydroxy-5-methylphenyl)propoxy]-2,4,8,10-tetra-t-butylbenz[d,f][1,3,2]dioxaphosphepin), trade name: Sumilizer GP manufactured by Sumitomo Chemical Co., Ltd.) at a concentration of 0.10 parts by mass based on 100 parts by mass of the polymer.

### Example 22

The resin composition described in Example 5 was melted at a resin temperature of 260° C. using a single-screw extruder having a screw diameter of 50 mmφ followed by passing through a T-die at a set temperature of 240° C. to continuously extrude a resin sheet. The extruded resin sheet was cooled by passing between a three-roll cooling roller having a mirrored surface to obtain a light guide plate having a thickness of 3 mm and width of 250 mm.

As a result of analyzing this unprocessed light guide plate, the concentration of residual phosphorus-based antioxidant was 400 μg/g, the concentration of phenol-based antioxidant was 440 μg/g, the TBC concentration was 1.2 μg/g, the Trimer 2 concentration was 540 μg/g, and the total amount of dimers and trimers was 2020 μg/g.

A test piece having an optical path length of 300 mm and width of 50 mm was cut out from this unprocessed light guide plate in the direction of resin flow, and the incident surface and exident surface thereof were polished with a polishing machine (Pla-Beauty PB-500 manufactured by Megarotechnica Co., Ltd.) so that the surfaces did not obstruct measurement of optical transmittance.

As a result of evaluating this test piece, optical transmittance A (mean transmittance of parallel light over a wavelength range of 420 nm to 500 nm, %) was 87.4%, optical transmittance B (mean transmittance of parallel light over a wavelength range of 500 nm to 600 nm, %) was 81.3%, optical transmittance C (mean transmittance of parallel light over a wavelength range of 420 nm to 500 nm following exposure treatment for 500 hours at 80° C.) was 78.0%, optical transmittance ratio (A/B) was 0.93, and optical transmission retention rate ((C/A)×100) was 96%.

Comparable optical transmission rates, optical transmission ratios and optical transmission retention rates are obtained for the compositions of other examples if the resulting unprocessed light guide plates are evaluated in the same manner.

### Comparative Example 1

A polystyrene-based resin composition was obtained using the same method as Example 1 with the exception of not adding a phosphorus-based antioxidant and adding 0.4 parts by mass of stearyl alcohol based on 100 parts by mass of the polymer.

### Comparative Example 2

A polystyrene-based resin composition was obtained using the same method as Example 1 with the exception of not adding a phosphorus-based antioxidant.

### Comparative Example 3

A polystyrene-based resin composition was obtained using the same method as Example 5 with the exception of not adding a phosphorus-based antioxidant and adding 0.4 parts by mass of stearyl alcohol based on 100 parts by mass of the polymer.

### Comparative Example 4

A styrene-based resin composition was obtained using the same method as Example 5 with the exception of adding 8.5 μg of TBC per 1 g of polymer simultaneous to adding phosphorus-based antioxidant and phenol-based antioxidant, and adding 0.4 parts by mass of stearyl alcohol based on 100 parts by mass of the polymer. The TBC concentration in the resulting polystyrene-based resin was 10 μg/g.

### Comparative Example 5

Styrene was obtained in which TBC content was below the detection limit (1 μg/g) by adding 1 part by mass of activated alumina to 100 parts by mass of styrene (TBC concentration: 11 μg/g), adsorbing the TBC and removing the activated alumina by filtration. A polystyrene-based resin composition was then obtained using the same method as Example 5 with the exception of using the resulting styrene for polymerization, and adding stearyl alcohol at a concentration of 0.4 parts by mass based on 100 parts by mass of the polymer.

### Comparative Example 6

A styrene-based resin composition was obtained using the same method as Comparative Example 3 with the exception of not adding stearyl alcohol.

### Comparative Example 7

A styrene-based resin composition was obtained using the same method as Comparative Example 4 with the exception of not adding stearyl alcohol.

### Comparative Example 8

A styrene-based resin composition was obtained using the same method as Comparative Example 5 with the exception of not adding stearyl alcohol.

TABLE 1

| | | Units | Ex. 1 | Ex. 2 | Ex. 3 | Ex. 4 | Ex. 5 | Ex. 6 | Ex. 7 |
|---|---|---|---|---|---|---|---|---|---|
| Phosphorus-based | Amt. added | Parts by | 0.05 | 0.10 | 0.05 | 0.05 | 0.05 | 0.10 | 0.05 |
| antioxidant | | mass | | | | | | | |
| Phenol-based antioxidant | Type | — | — | — | — | — | A | A | A |
| | Amt. added | Parts by | — | — | — | — | 0.05 | 0.05 | 0.10 |
| | | mass | | | | | | | |
| TBC | Content | μg/g | 1.5 | 1.5 | 1.2 | 5.5 | 1.5 | 1.5 | 1.5 |
| Dimers + trimers | Content | μg/g | 1710 | 1710 | 4720 | 1710 | 1710 | 1710 | 1710 |
| Trimer 2 | Content | μg/g | 520 | 520 | 2880 | 520 | 520 | 520 | 520 |
| Mold release agent | Type | — | — | — | — | — | — | — | — |
| | Amt. added | Parts by | — | — | — | — | — | — | — |
| | | mass | | | | | | | |
| Optical transmittance | Wavelength 420-520 nm: A | % | 80.9 | 82.1 | 80.1 | 81.5 | 80.6 | 81.2 | 79.8 |
| | Wavelength 500-600 nm: B | % | 87.0 | 87.3 | 86.1 | 87.6 | 86.7 | 86.4 | 85.8 |
| | Wavelength after heating | % | 75.2 | 76.3 | 74.5 | 75.8 | 77.4 | 78.0 | 77.4 |
| | 420-500 nm: C | | | | | | | | |
| Optical transmittance | A/B | — | 0.93 | 0.94 | 0.93 | 0.93 | 0.93 | 0.94 | 0.93 |
| ratio | | | | | | | | | |
| Optical transmittance | C/A × 100 | % | 93 | 93 | 93 | 93 | 96 | 96 | 97 |
| retention rate | | | | | | | | | |

| | | | | | | | | |
|---|---|---|---|---|---|---|---|---|
| Maximum retained pressure during lattice molding | MPa | — | — | — | — | — | — | — |

TABLE 2

| | | | Comp. | Comp. | Comp. | Comp. | Comp. | Comp. | Comp. | Comp. |
|---|---|---|---|---|---|---|---|---|---|---|
| Q | | Units | Ex. 1 | Ex. 2 | Ex. 3 | Ex. 4 | Ex. 5 | Ex. 6 | Ex. 7 | Ex. 8 |
| Phosphorus-based | Amt. added | Parts by | — | — | — | 0.05 | 0.05 | — | 0.05 | 0.05 |
| antioxidant | | mass | | | | | | | | |
| Phenol-based antioxidant | Type | — | — | — | A | A | A | A | A | A |
| | Amt. added | Parts by | — | — | 0.05 | 0.05 | 0.05 | 0.05 | 0.05 | 0.05 |
| | | mass | | | | | | | | |
| TBC | Content | μg/g | 1.5 | 1.5 | 1.5 | 10 | 0 | 1.5 | 10 | 0 |
| Dimers + trimers | Content | μg/g | 1710 | 1710 | 1710 | 1710 | 1710 | 1710 | 1710 | 1710 |
| Trimer 2 | Content | μg/g | 520 | 520 | 520 | 520 | 520 | 520 | 520 | 520 |
| Mold release agent | Type | — | A | — | A | A | A | — | — | |
| | Amt. added | Parts by | 0.4 | — | 0.4 | 0.4 | 0.4 | — | — | |
| | | mass | | | | | | | | |
| Optical transmittance | Wavelength 420-520 nm: A | % | 76.2 | 76.5 | 75.6 | 77.5 | 76.8 | 75.9 | 77.0 | 77.1 |
| | Wavelength 500-600 nm: B | % | 85.6 | 86.0 | 84.9 | 85.2 | 85.3 | 85.3 | 85.6 | 85.7 |
| | Wavelength after heating | % | 70.9 | 71.2 | 72.5 | 74.4 | 73.7 | 72.9 | 74.0 | 74.0 |
| | 420-500 nm: C | | | | | | | | | |
| Optical transmittance | A/B | — | 0.89 | 0.89 | 0.89 | 0.90 | 0.90 | 0.89 | 0.90 | 0.90 |
| ratio | | | | | | | | | | |
| Optical transmittance | C/A × 100 | % | 93 | 93 | 96 | 96 | 96 | 96 | 96 | 96 |
| retention rate | | | | | | | | | | |

| | | | | | | | | | |
|---|---|---|---|---|---|---|---|---|---|
| Maximum retained pressure during lattice molding | MPa | 2.8 | No mold | 2.8 | 2.8 | 2.8 | No mold | No mold | No mold |
| | | | separation | | | | separation | separation | separation |

The phosphorus-based antioxidant, phenol-based antioxidants and mold release agents shown in Tables 1 and 2 are as indicated below.

Phosphorus-based antioxidant: Tris(2,4-di-t-butylphenyl)phosphite (ADK Stab 2112, Adeka Corp.)

Phenol-based antioxidant A: Stearyl (3-(3,5-di-t-butyl-4-hydroxyphenyl)propionate (Irganox 1076, BASF Japan Ltd.)

Phenol-based antioxidant B: 6-[3-(3-t-butyl-4-hydroxy-5-methylphenyl)propoxy]-2,4,8,10-tetra-t-butylbenz[d,f][1,3,2]dioxaphosphepin (Sumilizer GP, Sumitomo Chemical Co., Ltd.)

Mold release agent A: Stearyl alcohol (NAA-45, NOF Corp.)

Mold release agent B: Stearic acid (Daiwax STF, Dainichi Chemical Industry Co., Ltd.)

Mold release agent C: Erucamide (Alflow P-10, NOF Corp.)

In Tables 1 and 2, “wavelength after heating 420-500 nm” refers to mean transmittance of parallel light over a wavelength range of 420 nm to 500 nm measured after exposure at 80° C. for 500 hours.

### INDUSTRIAL APPLICABILITY

A light guide plate obtained by molding the styrene-based resin composition of the present invention can be preferably used in a wide range of applications including the display devices of televisions, personal computer monitors (including desktop and notebook personal computers), car navigation system monitors, cell phones and lighting equipment for interior and exterior space as well as in billboards and the like.

1. A styrene-based resin composition containing 100 parts by mass of a styrene-based resin and 0.02 parts by mass to 0.2 parts by mass of a phosphorus-based antioxidant, wherein the content of 4-t-butylcatechol per 1 g of the styrene-based resin is 1 μg to 6 μg.

2. The styrene-based resin composition according to claim 1, further containing 0.02 parts by mass to 0.2 parts by mass of a phenol-based antioxidant.

3. The styrene-based resin composition according to claim 1, wherein the total content of dimers and trimers per 1 g of the styrene-based resin is 5000 μg or less, and the content of a trimer component (1a-phenyl-4-e-(1′-phenylethyl)tetralin) represented by the following structural formula (I): 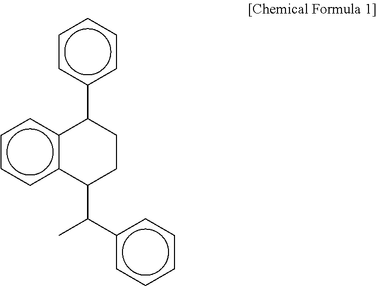
is less than 3000 μs.

4. The styrene-based resin composition according to claim 1, further containing 0.1 parts by mass to 1.0 part by mass of a mold release agent.

5. The styrene-based resin composition according to claim 4, wherein the mold release agent is a higher alcohol or higher fatty acid.

6. A light guide plate containing 100 parts by mass of a styrene-based resin and 0.02 parts by mass to 0.2 parts by mass of a phosphorus-based antioxidant, wherein the content of 4-t-butylcatechol per 1 g of the styrene-based resin is 1 μg to 6 μg.

7. The light guide plate according to claim 6, further containing 0.02 parts by mass to 0.2 parts by mass of a phenol-based antioxidant.

8. The light guide plate according to claim 6, wherein the total content of dimers and trimers per 1 g of the styrene-based resin is 5000 μg or less, and the content of a trimer component (1a-phenyl-4-e-(1′-phenylethyl)tetralin) represented by the following structural formula (I): 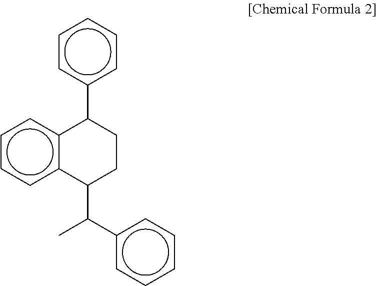
is less than 3000 μg.

9. The light guide plate according to claim 6, further containing 0.1 parts by mass to 1.0 part by mass of a mold release agent.

10. The light guide plate according to claim 9, wherein the mold release agent is a higher alcohol or higher fatty acid.

11. The styrene-based resin composition according to claim 2, wherein the total content of dimers and trimers per 1 g of the styrene-based resin is 5000 μg or less, and the content of a trimer component (1a-phenyl-4-e-(1′-phenylethyl)tetralin) represented by the following structural formula (I): 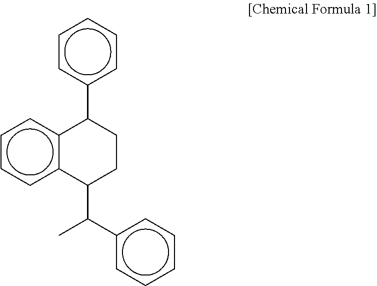
is less than 3000 μg.

12. The styrene-based resin composition according to claim 2, further containing 0.1 parts by mass to 1.0 part by mass of a mold release agent.

13. The styrene-based resin composition according to claim 3, further containing 0.1 parts by mass to 1.0 part by mass of a mold release agent.

14. The styrene-based resin composition according to claim 11, further containing 0.1 parts by mass to 1.0 part by mass of a mold release agent.

15. The styrene-based resin composition according to claim 12, wherein the mold release agent is a higher alcohol or higher fatty acid.

16. The styrene-based resin composition according to claim 13, wherein the mold release agent is a higher alcohol or higher fatty acid.

17. The styrene-based resin composition according to claim 14, wherein the mold release agent is a higher alcohol or higher fatty acid.

18. The light guide plate according to claim 7, wherein the total content of dimers and trimers per 1 g of the styrene-based resin is 5000 μg or less, and the content of a trimer component (1a-phenyl-4-e-(1′-phenylethyl)tetralin) represented by the following structural formula (I): 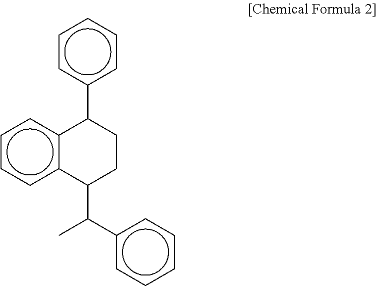
is less than 3000 μg.

19. The light guide plate according to claim 7, further containing 0.1 parts by mass to 1.0 part by mass of a mold release agent.

20. The light guide plate according to claim 8, further containing 0.1 parts by mass to 1.0 part by mass of a mold release agent.
